(19) United States
(12) Patent Application Publication
(10) Pub. No.: US 2003/0070300 A1
(43) Pub. Date: Apr. 17, 2003

(54) Structure for a locating pivot of shears

(75) Inventor: Chin-Chi Huang, Chung Hwa Hsien (TW)

Correspondence Address: HARRISON & EGBERT, 412 MAIN STREET, 7TH FLOOR, HOUSTON, TX, 77002, US

(73) Assignee: Hung Chuan Hsian Industries Co., Ltd.

(21) Appl. No.: 09/976,711

(22) Filed: Oct. 15, 2001

(51) Int. Cl. B26B 13/00

(52) U.S. Cl. 30/262; 30/261; 30/249

(57) ABSTRACT

A pivoting structure is provided to pivot together a first working block, a cutting blade, and a second working block of a pair of shears in such a manner that the cutting blade and the second working block work against each other to effect the scissors action. The pivoting structure comprises a first locating slot disposed in the first working block, a pivot located in the first locating slot, a second locating slot disposed in the second working block, and a nut engaged with the pivot and located in the second locating slot.

### BACKGROUND OF THE INVENTION

1. Field of the Invention

The present invention relates generally to a pair of shears, and more particularly to a structure for pivoting two opposing blades of the shears.

2. Description of Related Art

As shown in FIGS. 1 and 2, a cutting device 10 of the prior art comprises two main bodies 11 and 12, each having a blade 13. The two opposing blades 13 are pivoted together by a pivoting structure 18 which is formed of a pivot 16 and a nut 17, thereby enabling the two opposing blades 13 to work against each other. The pivoting structure 18 of the prior art device 10 is susceptible to impact by a foreign object, thereby resulting in the loosening of the pivoting structure 18. As a. result, the scissors action of two cutting edges of the two opposing blades 13 is seriously undermined.

### BRIEF SUMMARY OF THE INVENTION

The primary objective of the present invention is to provide a pair of shears with means to locate securely a pivoting structure of the shears, so as to overcome the deficiency of the prior art shears described above.

In keeping with the principle of the present invention, the foregoing objective of the present invention is attained by a cutting instrument comprising two handles, two working block, and a structure for pivoting the two working blocks together so that they work against each other to effect the scissors action. The pivoting structure comprises a pivot, a nut, and two locating slots which are disposed respectively in the two working blocks for locating the pivot and the nut so as to prevent the pivot and the nut from becoming loosened.

The features and the functions of the present invention will be more readily understood upon a thoughtful deliberation of the following detailed description of a preferred embodiment of the present invention with reference to the accompanying drawings.

### BRIEF DESCRIPTION OF THE SEVERAL VIEWS OF THE DRAWINGS

FIG. 1 shows an exploded view of a pivoting structure of a prior art pair of shears.

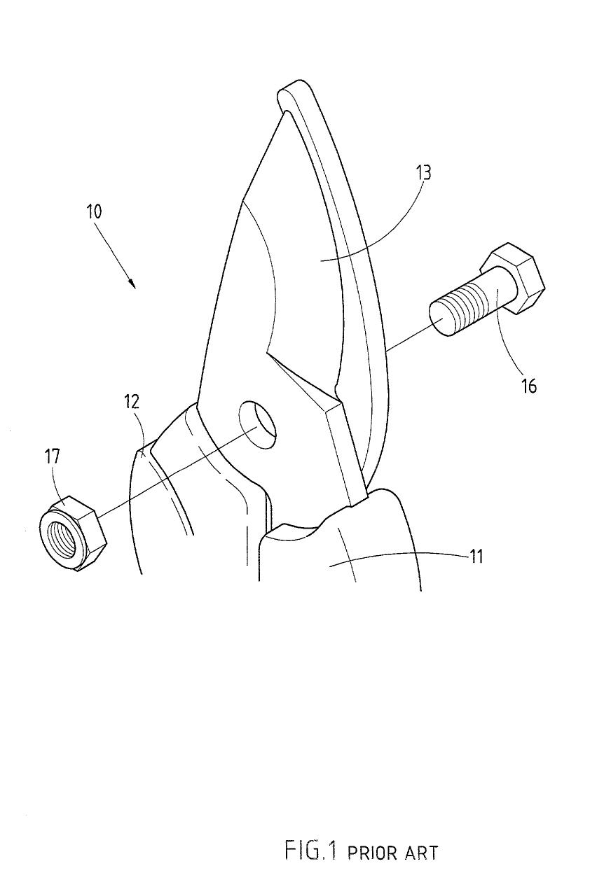

FIG. 2 shows a sectional view of the pivoting structure of prior art shears in combination.

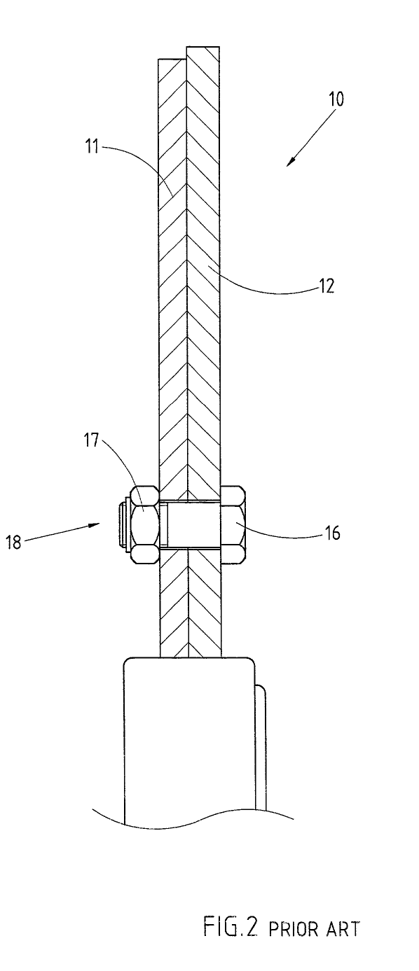

FIG. 3 shows a perspective view of a pair of shears of the preferred embodiment of the present invention.

FIG. 4 shows an exploded view of the shears of the preferred embodiment of the present invention.

FIG. 5 shows a sectional view of the pivoting structure of the shears of the preferred embodiment of the present invention.

### DETAILED DESCRIPTION OF THE INVENTION

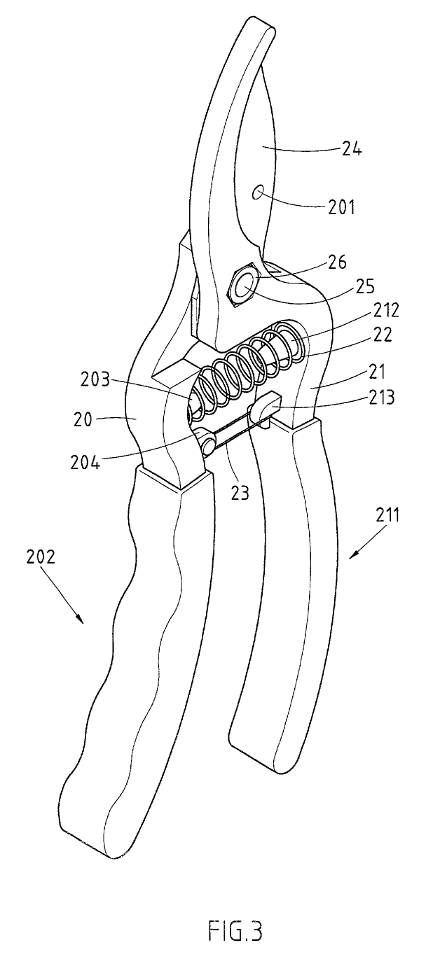

As shown in FIGS. 3-5, the preferred embodiment of the present invention comprises a first handle 202, a first working block 20 extending from one end of the first handle 202, a cutting blade 24 retained by the first working block 20, a second handle 211, a second working block 21 extending from one end of the second handle 211, and a pivoting structure for pivoting the first working block 20, the cutting blade 24, and the second working block 21 together such that the cutting blade 24 and the second working block 21 work against each other so as to bring about the scissors effect.

The first working block 20 is provided with two retaining projections 201 for retaining the cutting blade 24, a first locating pillar 203, a first retaining protrusion 204, and a retaining piece 23 whose one end is held by the retaining protrusion 204.

The second working block 21 is provided with a second locating pillar 212 corresponding in location to the first locating pillar 203 of the first working block 20, a second retaining protrusion 213 corresponding in location to the first retaining protrusion 204 of the first working block 20, and a spring 22 fitted at one end over the second locating pillar 212. The second working block 21 and the first working block 20 are joined together such that other end of the retaining piece 23 is held by the second retaining protrusion 213 of the second working block 21, and that other end of the spring 22 is fitted over the first locating pillar 203 of the first working block 20.

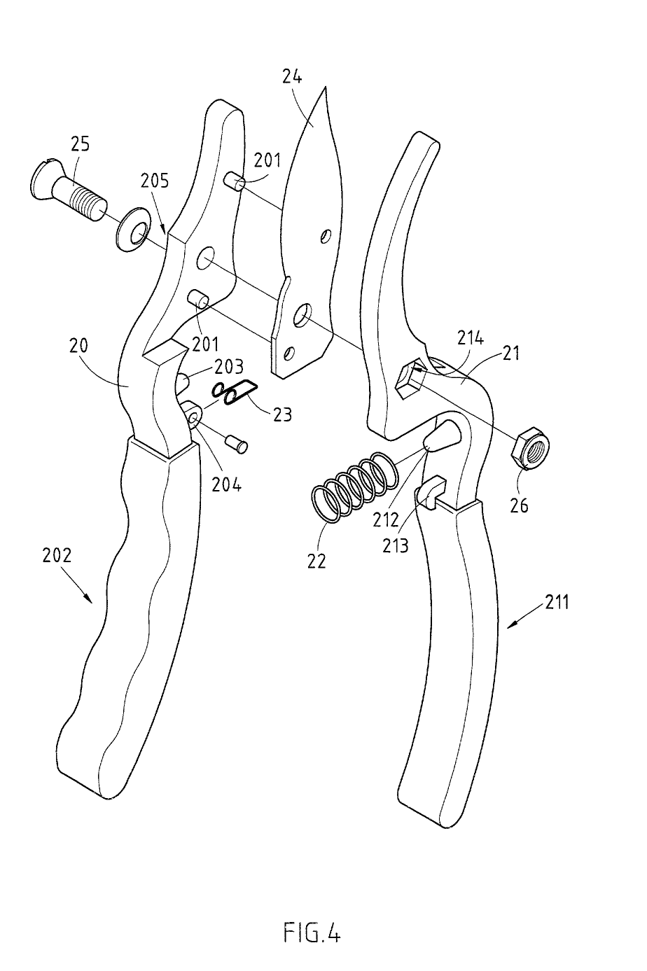

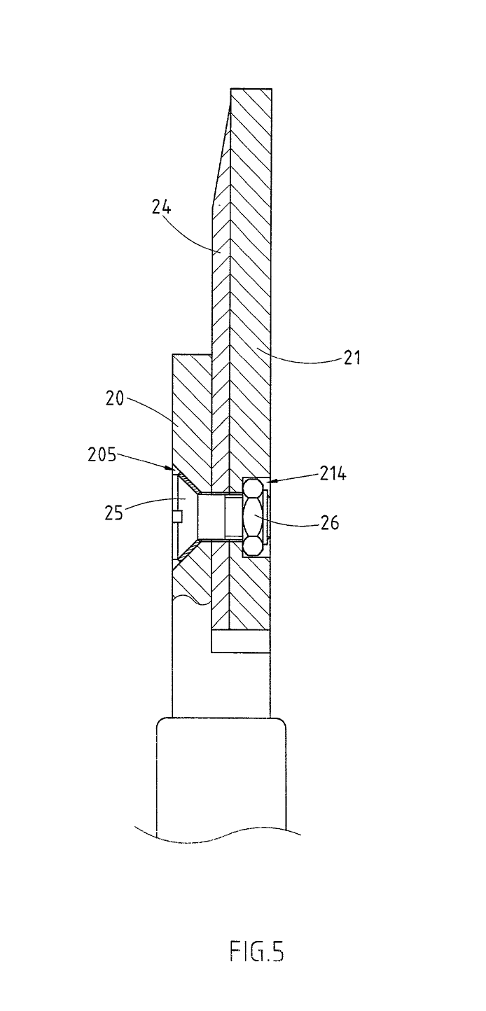

The first working block 20, the cutting blade 24, and the second working block 21 are pivoted together by a pivoting structure comprising a pivot 25, a first locating slot 205 in which the pivot 25 is located, a nut 26 which is engaged with the pivot 25, and a second locating slot 214 in which the nut 26 is located. The first locating slot 205 is disposed in the outer side wall of the first working block 20, whereas the second locating slot 214 is disposed in the outer side wall of the second working block 21, as shown in FIGS. 4 and 5.

In view of the fact that the head of the pivot 25 is inserted into the first locating slot 205 of the first working block 20, and that the nut 26 is fitted into the second locating slot 214 of the second working block 21, the pivot 25 and the nut 26 of the pivoting structure of the present invention are not vulnerable to impact or mechanical friction by a foreign object. In other words, the pivot 25 and the nut 26 of the present invention can not be easily loosened by the external force of the foreign object.

The embodiment of the present invention described above is to be regarded in all respects as being merely illustrative and nonrestrictive. Accordingly, the present invention may be embodied in other specific forms without deviating from the spirit thereof. The present invention is therefore to be limited only by the scope of the following claim.

I claim:

1. A pair of shears comprising:
a first handle;
a first working block extending from one end of said first handle;
a cutting blade retained by said first working block; a second handle;
a second working block extending form one end of said second handle; and
a pivoting structure for pivoting together said first working block, said cutting blade, and said second working block such that said cutting blade and said second working block work against each other to effect the scissors action;
wherein said pivoting structure comprises:
a pivot;
a first locating slot disposed in said first working block for locating said pivot; a nut engaged with said pivot; and
a second locating slot disposed in said second working block for locating said nut.
